(19) United States
(12) Patent Application Publication
(10) Pub. No.: US 2013/0222632 A1
(43) Pub. Date: Aug. 29, 2013

(54) ELECTRONIC CAMERA

(71) Applicant: SANYO ELECTRIC CO., LTD., (US)

(72) Inventors: Masayoshi OKAMOTO, Daito-shi (JP); Jun Kiyama, Higashiosaka-shi (JP)

(73) Assignee: SANYO ELECTRIC CO., LTD., Moriguchi-shi (JP)

(21) Appl. No.: 13/773,128

(22) Filed: Feb. 21, 2013

(30) Foreign Application Priority Data
Feb. 27, 2012 (JP) 2012-040172

(51) Int. Cl. H04N 5/232

(52) U.S. Cl. CPC H04N 5/23219
USPC 348/222.1

(57) ABSTRACT

An electronic camera includes an imager. An imager repeatedly outputs an image representing a scene. A first searcher searches for a specific object image from the image outputted from the imager, corresponding to a first mode. A first detector detects a size of the specific object image detected by the first searcher. A first adjuster adjusts an imaging condition by noticing the specific object image detected by the first searcher. A second searcher searches for a partial image equivalent to the specific object image detected by the first searcher from the image outputted from the imager, corresponding to a second mode which substitutes for the first mode. A second adjuster adjusts the imaging condition based on a difference between a size of the partial image detected by the second searcher and the size detected by the first detector and an adjustment result of the first adjuster.

### CROSS REFERENCE OF RELATED APPLICATION

The disclosure of Japanese Patent Application No. 2012-40172, which was filed on Feb. 27, 2012, is incorporated herein by reference.

### BACKGROUND OF THE INVENTION

1. Field of the Invention

The present invention relates to an electronic camera, and in particular, relates to an electronic camera which adjusts an imaging condition based on an optical image generated on an imaging surface.

2. Description of the Related Art

According to one example of this type of camera, an AF processor performs a focus control based on a signal from a predetermined AF area within image data. An extractor extracts a characteristic region from the image data. A face identifier identifies a face of a person from among the characteristic region extracted by the extractor. A determiner determines whether or not a size of the face identified by the face identifier is equal to or more than a predetermined value. A setter sets the AF area depending on a determined result of the determiner.

However, in the above-described camera, individual differences of the sizes of the faces are not considered, and therefore, there is a possibility that an error occurs when the imaging condition is determined from the identified size of the face. For example, when the imaging condition is determined by noticing a face of a child, an adjustment accuracy may be deteriorated by referring to an average size of the face of the person and a subject distance.

### SUMMARY OF THE INVENTION

An electronic camera according to the present invention comprises: an imager which repeatedly outputs an image representing a scene; a first searcher which searches for a specific object image from the image outputted from the imager, corresponding to a first mode; a first detector which detects a size of the specific object image detected by the first searcher; a first adjuster which adjusts an imaging condition by noticing the specific object image detected by the first searcher; a second searcher which searches for a partial image equivalent to the specific object image detected by the first searcher from the image outputted from the imager, corresponding to a second mode which substitutes for the first mode; and a second adjuster which adjusts the imaging condition based on a difference between a size of the partial image detected by the second searcher and the size detected by the first detector and an adjustment result of the first adjuster.

According to the present invention, an imaging control program recorded on a non-transitory recording medium in order to control an electronic camera provided with an imager which repeatedly outputs an image representing a scene, the program causing a processor of the electronic camera to perform the steps comprises: a first searching step of searching for a specific object image from the image outputted from the imager, corresponding to a first mode; a first detecting step of detecting a size of the specific object image detected by the first searching step; a first adjusting step of adjusting an imaging condition by noticing the specific object image detected by the first searching step; a second searching step of searching for a partial image equivalent to the specific object image detected by the first searching step from the image outputted from the imager, corresponding to a second mode which substitutes for the first mode; and a second adjusting step of adjusting the imaging condition based on a difference between a size of the partial image detected by the second searching step and the size detected by the first detecting step and an adjustment result of the first adjusting step.

According to the present invention, an imaging control method executed by an electronic camera provided with an imager which repeatedly outputs an image representing a scene, comprises: a first searching step of searching for a specific object image from the image outputted from the imager, corresponding to a first mode; a first detecting step of detecting a size of the specific object image detected by the first searching step; a first adjusting step of adjusting an imaging condition by noticing the specific object image detected by the first searching step; a second searching step of searching for a partial image equivalent to the specific object image detected by the first searching step from the image outputted from the imager, corresponding to a second mode which substitutes for the first mode; and a second adjusting step of adjusting the imaging condition based on a difference between a size of the partial image detected by the second searching step and the size detected by the first detecting step and an adjustment result of the first adjusting step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an assignment state of an evaluation area in an imaging surface;

FIG. 5 is an illustrative view showing one example of a face-detection frame structure used in a face detecting process;

FIG. 6 is an illustrative view showing one example of a configuration of a face dictionary referred to in the face detecting process;

FIG. 7 is an illustrative view showing one example of a configuration of a human-body dictionary referred to in a human-body detecting process;

FIG. 8 is an illustrative view showing one example of a configuration of a register referred to in the embodiment in FIG. 2;

FIG. 9 is an illustrative view showing one example of a configuration of another register referred to in the embodiment in FIG. 2;

FIG. 10 is an illustrative view showing one example of a configuration of a face dictionary registered and referred to in the embodiment in FIG. 2;

FIG. 11 is an illustrative view showing one portion of the face detecting process;

FIG. 12 is an illustrative view showing one portion of a registration process;

FIG. 13 is an illustrative view showing another portion of the registration process;

FIG. 14 is an illustrative view showing one example of a configuration of still another register referred to in the embodiment in FIG. 2;

FIG. 15 is an illustrative view showing one example of a configuration of yet another register referred to in the embodiment in FIG. 2;

FIG. 16 is an illustrative view showing one portion of a strict AF process;

FIG. 17 is an illustrative view showing one portion of an AF process for person;

FIG. 18 is an illustrative view showing another portion of the AF process for person;

FIG. 19 is a flowchart showing one portion of behavior of a CPU applied to the embodiment in FIG. 2;

FIG. 20 is a flowchart showing another portion of behavior of the CPU applied to the embodiment in FIG. 2;

FIG. 21 is a flowchart showing still another portion of behavior of the CPU applied to the embodiment in FIG. 2;

FIG. 22 is a flowchart showing yet another portion of behavior of the CPU applied to the embodiment in FIG. 2;

FIG. 23 is a flowchart showing another portion of behavior of the CPU applied to the embodiment in FIG. 2;

FIG. 24 is a flowchart showing still another portion of behavior of the CPU applied to the embodiment in FIG. 2;

FIG. 25 is a flowchart showing yet another portion of behavior of the CPU applied to the embodiment in FIG. 2;

FIG. 26 is a flowchart showing another portion of behavior of the CPU applied to the embodiment in FIG. 2;

FIG. 27 is a flowchart showing still another portion of behavior of the CPU applied to the embodiment in FIG. 2;

FIG. 28 is a flowchart showing yet another portion of behavior of the CPU applied to the embodiment in FIG. 2;

FIG. 29 is a flowchart showing another portion of behavior of the CPU applied to the embodiment in FIG. 2;

FIG. 30 is a flowchart showing still another portion of behavior of the CPU applied to the embodiment in FIG. 2;

FIG. 31 is a flowchart showing yet another portion of behavior of the CPU applied to the embodiment in FIG. 2;

FIG. 32 is a flowchart showing another portion of behavior of the CPU applied to the embodiment in FIG. 2; and

FIG. 33 is a block diagram showing a configuration of another embodiment of the present invention.

### DETAILED DESCRIPTION OF THE PREFERRED EMBODIMENTS

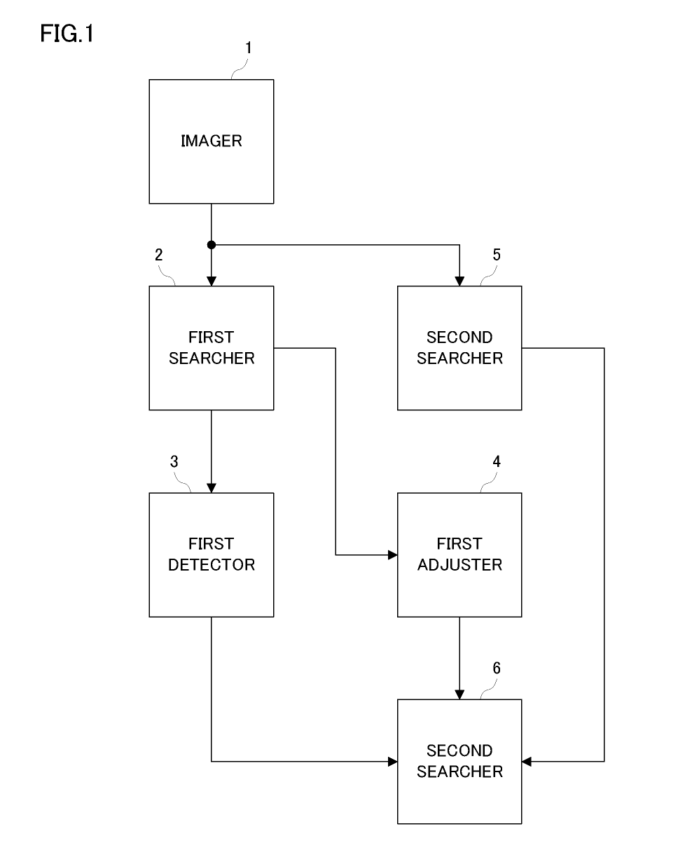

With reference to FIG. 1, an electronic camera according to one embodiment of the present invention is basically configured as follows: An imager 1 repeatedly outputs an image representing a scene. A first searcher 2 searches for a specific object image from the image outputted from the imager 1, corresponding to a first mode. A first detector 3 detects a size of the specific object image detected by the first searcher 2. A first adjuster 4 adjusts an imaging condition by noticing the specific object image detected by the first searcher 2. A second searcher 5 searches for a partial image equivalent to the specific object image detected by the first searcher 2 from the image outputted from the imager 1, corresponding to a second mode which substitutes for the first mode. A second adjuster 6 adjusts the imaging condition based on a difference between a size of the partial image detected by the second searcher 5 and the size detected by the first detector 2 and an adjustment result of the first adjuster 4.

The specific object image is searched based on the image once detected. Moreover, the imaging condition is adjusted based on a difference between the sizes of the specific object images of twice detections and the adjustment result of the first detection. Thereby, it becomes possible to improve an adjustment accuracy of the imaging condition more than adjusting based on a standard size.

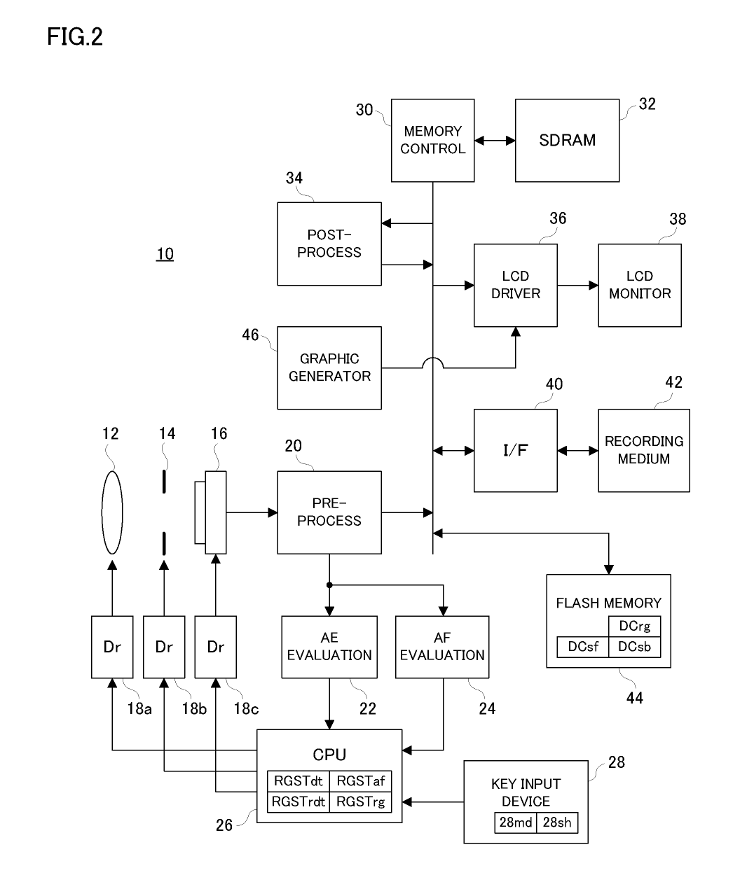

With reference to FIG. 2, a digital camera 10 according to one embodiment includes a focus lens 12 and an aperture unit 14 driven by drivers 18a and 18b, respectively. An optical image that underwent these components enters, with irradiation, an imaging surface of an imaging surface of an image sensor 16, and is subjected to a photoelectric conversion. Thereby, electric charges representing a scene are produced.

When a power source is applied, under a main task, a CPU 26 determines a state of a mode changing button 28md arranged in a key input device 28 (i.e., an operation mode at a current time point). As a result of determination, a person registration task or an imaging task is activated respectively corresponding to a person registration mode or an imaging mode.

When the person registration mode is selected, the CPU 26 places the focus lens 12 at a pan focus position which is an initial setting position. Subsequently, in order to execute a moving image taking process, the CPU 26 commands a driver 18 to repeat an exposure procedure and an electric-charge reading-out procedure. In response to a vertical synchronization signal Vsync periodically generated from an SG (Signal Generator) not shown, the driver 18c exposes the imaging surface and reads out the electric charges produced on the imaging surface in a raster scanning manner. From the image sensor 16, raw image data that is based on the read-out electric charges is cyclically outputted.

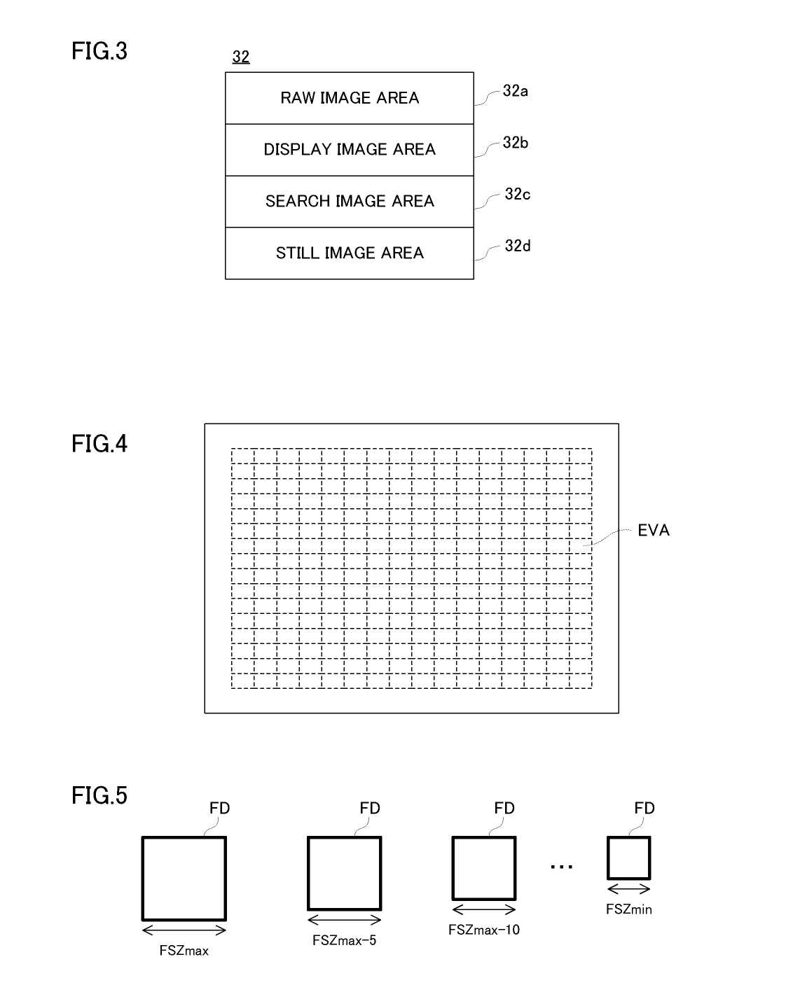

A pre-processing circuit 20 performs processes, such as digital clamp, pixel defect correction, gain control and etc., on the raw image data outputted from the imager 16. The raw image data on which these processes are performed is written into a raw image area 32a of an SDRAM 32 (see FIG. 3) through a memory control circuit 30.

A post-processing circuit 34 reads out the raw image data stored in the raw image area 32a through the memory control circuit 30, and performs a color separation process, a white balance adjusting process and a YUV converting process, on the read-out raw image data. Furthermore, the post-processing circuit 34 executes a zoom process for display and a zoom process for search to image data that comply with a YUV format, in a parallel manner. As a result, display image data and search image data that comply with the YUV format are individually created. The display image data is written into a display image area 32b of the SDRAM 32 (see FIG. 3) by the memory control circuit 30. The search image data is written into a search image area 32c of the SDRAM 32 (see FIG. 3) by the memory control circuit 30.

An LCD driver 36 repeatedly reads out the display image data stored in the display image area 32b through the memory control circuit 30, and drives an LCD monitor 38 based on the read-out image data. As a result, a real-time moving image (a live view image) representing the scene is displayed on the LCD monitor 38.

With reference to FIG. 4, an evaluation area EVA is assigned to a center of the imaging surface. The evaluation area EVA is divided into 16 portions in each of a horizontal direction and a vertical direction; therefore, the evaluation area EVA is formed of 256 divided areas. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, at every time the vertical synchronization signal Vsync is generated. Thereby, 256 integral values (256 AE evaluation values) are outputted from the AE evaluating circuit 22 in response to the vertical synchronization signal Vsync.

An AF evaluating circuit 24 integrates a high-frequency component of the RGB data belonging to the evaluation area EVA, out of the RGB data generated by the pre-processing circuit 20, at every time the vertical synchronization signal Vsync is generated. Thereby, 256 integral values (256 AF evaluation values) are outputted from the AF evaluating circuit 24 in response to the vertical synchronization signal Vsync.

When a shutter button 28sh is in a non-operated state, under the person registration task, the CPU 26 executes a simple AE process that is based on output from the AE evaluating circuit 22 so as to calculate an appropriate EV value. An aperture amount and an exposure time period that define the calculated appropriate EV value are set to the drivers 18b and 18c, respectively, and as a result, a brightness of the live view image is adjusted approximately.

When a registration-use-face detecting task executed in parallel with the imaging task is activated, the CPU 26 sets a flag FLG_rf to “0” as an initial setting.

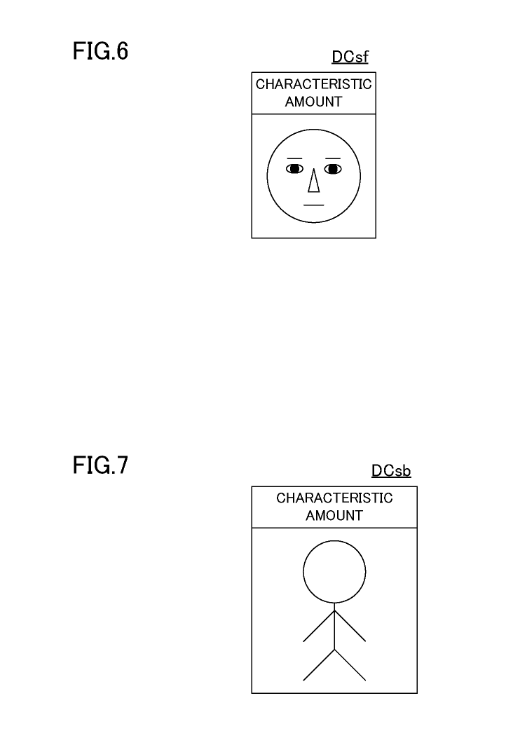

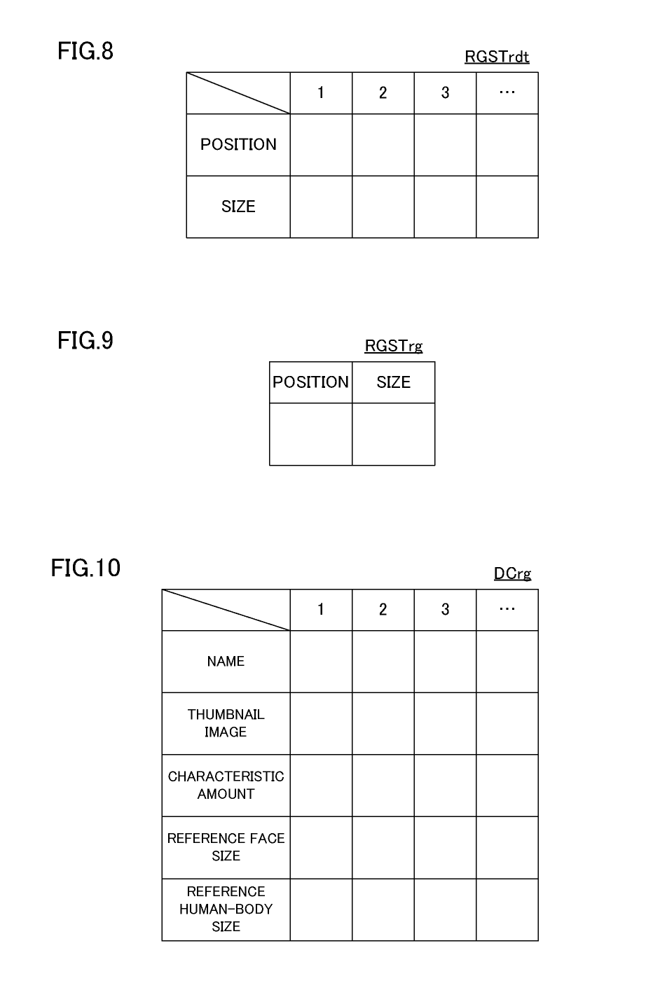

Subsequently, in order to search for a face image of a person from the search image data stored in the search image area 32c, the CPU 26 executes a registration-use-face detecting process under the registration-use-face detecting task, at every time the vertical synchronization signal Vsync is generated. For the registration-use-face detecting task, prepared are a plurality of face-detection frame structures FD, FD, FD, . . . shown in FIG. 5, a standard dictionary DCsf shown in FIG. 6, a standard human-body dictionary DCsb shown in FIG. 7, a registration-use-face detection register RGSTrdt shown in FIG. 8, a registration-target register RGSTrg shown in FIG. 9, and a registered face dictionary DCrg. The standard face dictionary DCsf contains a standard characteristic amount of the face of the person, and the standard human-body dictionary DCsb contains a standard characteristic amount of the human-body.

It is noted that the standard human-body dictionary DCsb, the registered face dictionary DCrg and the plurality of face-detection frame structures FD, FD, FD, . . . are used also in an imaging-use-face detecting task described later. Moreover, the standard face dictionary DCsf, the standard human-body dictionary DCsb and the registered face dictionary DCrg are saved in a flash memory 44.

In the registration-use-face detecting process, firstly, the whole evaluation area EVA is set as a search area. Moreover, in order to define a variable range of the size of the face-detection frame structure FD, a maximum size SZmax is set to “200”, and a minimum size SZmin is set to “20”.

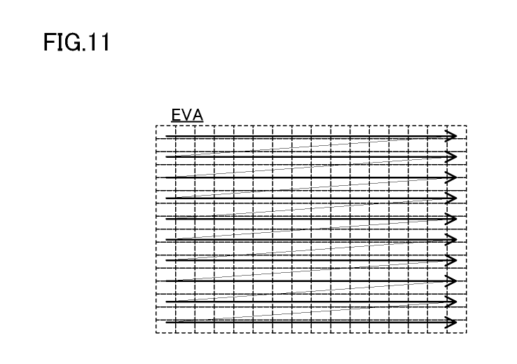

The face-detection frame structure FD is moved by each predetermined amount in the raster scanning manner, from a start position (an upper left position) toward an ending position (a lower right position) of the search area (see FIG. 11). Moreover, the size of the face-detection frame structure FD is reduced by a scale of “5” from “SZmax” to “SZmin” at every time the face-detection frame structure FD reaches the ending position.

The CPU 26 reads out image data belonging to the face-detection frame structure FD from the search image area 32c through the memory control circuit 30 so as to calculate a characteristic amount of the read-out search image data. The calculated characteristic amount is compared with a characteristic amount of the standard face dictionary DCsf. When a matching degree exceeds a reference value TH1, it is regarded that the face image has been detected, and a position and a size of the face-detection frame structure FD at a current time point are stored, as face information, in the registration-use-face-detection register RGSTrdt

After the registration-use-face detecting process is completed, when the face information is stored in the registration-use-face-detection register RGSTrdt, the CPU 26 determines face information to be registered from among the face information stored in the registration-use-face-detection register RGSTrdt. When a piece of face information is stored in the registration-use-face-detection register RGSTrdt, the CPU 26 uses the stored face information as registered target face information. When a plurality of face information are stored in the registration-use-face-detection register RGSTrdt, the CPU 26 uses face information in which a position is the nearest to the center of the imaging surface, as the registered target face information. A position and a size of the face information used as the registered target face information are stored in the registration-target register RGSTrg.

Moreover, in order to declare that the face of the person has been discovered, the CPU 26 sets the flag FLG_rf to “1”.

It is noted that, after the registration-use-face detecting process is completed, when the face information has not been registered in the the registration-use-face-detection register RGSTrdt, i.e., when the face of the person has not been discovered, the CPU 26 sets the flag FLG_rf to “0” in order to declare that the face of the person is undiscovered.

When the shutter button 28sh is half-depressed, under the person registration task, the CPU 26 executes a strict AE process based on the 256 AE evaluation values outputted from the AE evaluating circuit 22. An aperture amount and an exposure time period that define the optimal EV value calculated by the strict AE process are set to the drivers 18b and 18c, respectively. Thereby, the brightness of the live view image is adjusted strictly.

When the flag FLG_rf indicates “1”, under the person registration task, the CPU 26 executes a strict AF process in which a region indicated by the registered target face information is noticed. The CPU 26 extracts, out of the 256 AF evaluation values outputted from the AF evaluating circuit 24, an AF evaluation value corresponding to the position and size stored in the registration target register RGSTrg. The CPU 26 executes an AF process that is based on the extracted partial AF evaluation value. As a result, the focus lens 12 is placed at a focal point in which the region indicated by the registered target face information is noticed, and thereby, a sharpness of a face of a registration target in the live view image is improved.

Moreover, when the flag FLG_rf indicates “1”, under the person registration task, the CPU 26 requests a graphic generator 46 to display a face frame structure RF with reference to contents of the registration-target register RGSTrg. The graphic generator 46 outputs graphic information representing the face frame structure RF toward the LCD driver 38. The face frame structure RF is displayed on the LCD monitor 38 in a manner adapted to the position and size stored in the registration-target register RGSTrg.

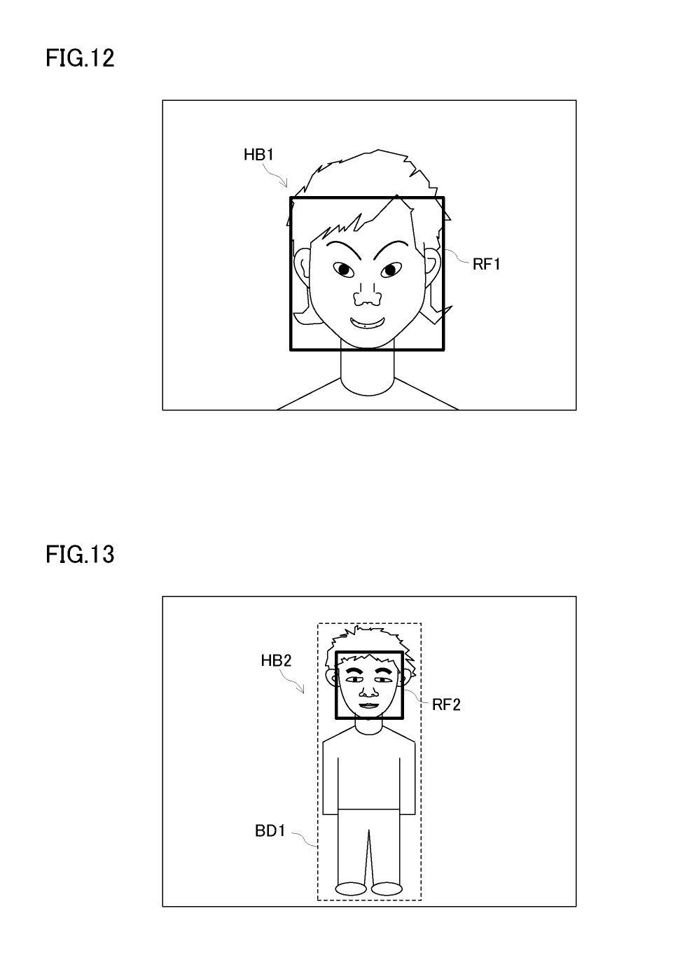

Thus, when a face of a person HB1 is captured by the imaging surface, a face frame structure RF 1 is displayed on the LCD monitor 38 as shown in FIG. 12, in a manner to surround a face image of the person HB1.

When the shutter button 28sh is fully depressed, in order to register a dictionary on the registration-use-face dictionary DCrg based on the registered target face information, the CPU 26 executes a registration process under the person registration task

In the registration process, firstly, a still-image taking process is executed. One frame of image data at a time point at which the shutter button 28sh is fully depressed is taken into a still image area 32d of the SDRAM 32 by the still-image taking process. Moreover, updating the display image area 32b is stopped, and a still image at the time point at which the shutter button 28sh is fully depressed is displayed on the LCD monitor 38.

Image data corresponding to the position and size stored in the registration-target register RGSTrg out of the display image data is registered in the registered face dictionary DCrg as a thumbnail image, and a characteristic amount of the image data is registered in the registered face dictionary DCrg.

Subsequently, the CPU 26 calculates a reference face size Sf representing a size per unit subject distance of the registered target face information. The reference face size Sf is obtained by Equation 1 indicated below.

Sf=Rf/Rd [Equation 1]
Rf: the size stored in the registration-target register RGSTrg
Rd: a subject distance set at a current time point

The reference face size Sf thus calculated is registered in the registered face dictionary DCrg. It is noted that, since the strict AF process in which the region indicated by the registered target face information is noticed is already executed, the subject distance set at a current time point is equivalent to a distance of a person indicated by the registered target face information and the focus lens.

Moreover, the CPU 26 detects by using the standard human-body dictionary DCsb an image of the human body including the region indicated by the registered target face information, from the search image data. When the human-body image is detected, the CPU 26 calculates a reference human-body size Sb representing a size per unit subject distance of the detected human-body image. The reference human-body size Sb is obtained by Equation 2 indicated below

Sb=Rb/Rd [Equation 2]
Rb: the size of the human-body image

The reference human-body size Sb thus calculated is registered in the registered face dictionary DCrg. For example, when a face of a person HB2 is captured by the imaging surface, a face frame structure RF2 is displayed on the LCD monitor 38 as shown in FIG. 13, in a manner to surround a face image of the person HB2. At this time, a whole body of the person HB2 is captured by the imaging surface, and therefore, a human-body of the person HB2 is also detected by a human-body-detection frame structure BD1. In this case, the reference human-body size Sb is registered in the registered face dictionary DCrg together with the reference face size SE

Subsequently, the CPU 26 displays an input screen so as to promote an operator to input a name of the registration target. The inputted name is registered in the registered face dictionary DCrg, and the registration process is completed.

It is noted that, if the shutter button 28sh is fully depressed when the flag FLG_rf indicates “0”, in order to declare that the face of the person is undiscovered, an error message is displayed on the LCD monitor 38.

When the imaging mode is selected, the CPU 26 places the focus lens 12 at the pan focus position which is the initial setting position. Subsequently, the CPU 26 executes the moving image taking process. As a result, a live view image representing the scene is displayed on the LCD monitor 38.

When the shutter button 28sh is in the non-operated state, the CPU 26 executes the simple AE process under the imaging task As a result, a brightness of the live view image is adjusted approximately.

When the imaging-use-face detecting task executed in parallel with the imaging task is activated, the CPU 26 sets a flag FLG_f to “0” as an initial setting.

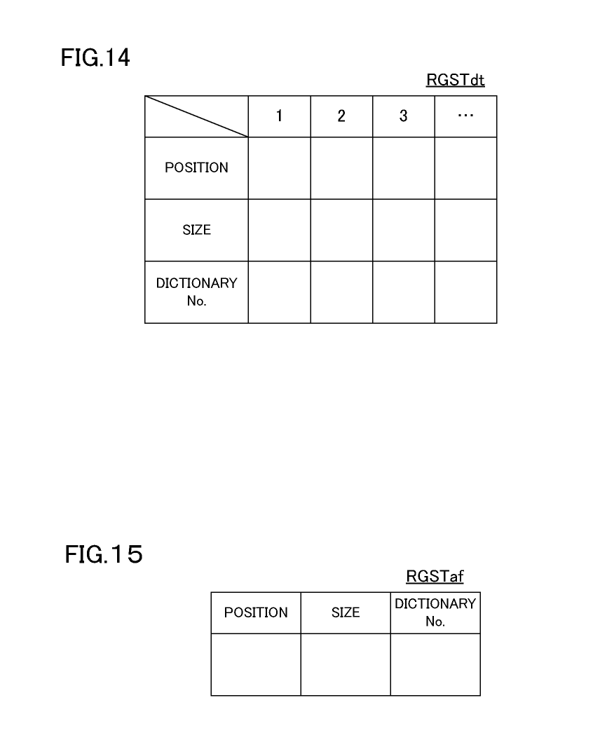

Subsequently, in order to search for the face image of the person from the search image data stored in the search image area 32c, the CPU 26 executes an imaging-use-face detecting process under the imaging-use-face detecting task, at every time the vertical synchronization signal Vsync is generated. For the imaging-use-face detecting task, prepared are an imaging-use-face detection register RGSTdt shown in FIG. 14 and an AF-target register RGSTaf shown in FIG. 15.

In the imaging-use-face detecting process, similarly to the registration-use-face detecting process described above, the whole evaluation area EVA is set as a search area, the face-detection frame structure FD is moved from the upper left position toward the lower right position of the search area, and the size is reduced by a scale of “5” from “SZmax” to “SZmin” at every time of reaching the lower right position.

However, in the imaging-use face detecting process, unlike the registration-use-face detecting process, the characteristic amount of the image data belonging to the face-detection frame structure FD is compared with each of the characteristic amounts registered in the registered face dictionary DCrg. When a matching degree exceeds a reference value TH2, it is regarded that the face image has been detected, and a position and a size of the face-detection frame structure FD at a current time point and a dictionary number of a comparing target are registered, as face information, in the imaging-use-face-detection register RGSTdt.

After the imaging-use-face detecting process is completed, when the face information is stored in the imaging-use-face-detection register RGSTdt, the CPU 26 determines face information to be a target of the AF process from among the face information stored in the imaging-use-face-detection register RGSTdt. When a piece of face information is registered in the imaging-use-face-detection register RGSTdt, the CPU 26 uses the stored face information as AF-target face information. When a plurality of face information are registered in the imaging-use-face-detection register RGSTdt, the CPU 26 uses face information in which a position is the nearest to the center of the imaging surface, as the AF-target face information. A position and a size of the face information used as the AF-target face information and the dictionary number are registered in the AF-target register RGSTaf.

Moreover, in order to declare that the face of the person has been discovered, the CPU 26 sets the flag FLG_f to “1”.

When the shutter button 28sh is half-depressed and the flag FLG_f indicates “1”, the CPU 26 executes an AF process for person under the imaging task.

In the AF process for person, firstly, executed is a strict AF process in which a region indicated by the AF-target face information is noticed. The CPU 26 extracts, out of the 256 AF evaluation values outputted from the AF evaluating circuit 24, an AF evaluation value corresponding to the position and size registered in the AF target register RGSTaf. The CPU 26 executes an AF process that is based on the extracted partial AF evaluation value. As a result, the focus lens 12 is placed at a focal point in which the region indicated by the AF-target face information is noticed, and thereby, improved is a sharpness of the region indicated by the AF-target face information in the live view image or the recorded image. Moreover, a subject distance after the strict AF process is completed is set as an AF distance Da.

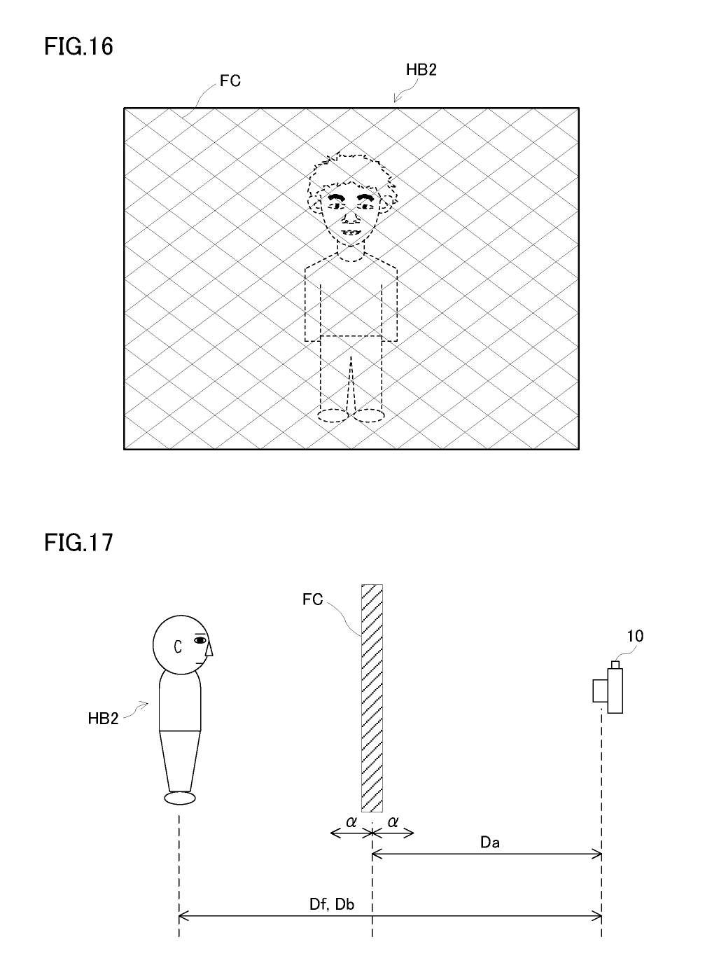

As a result of the strict AF process, if an obstacle constructed by grid-like wire meshes, etc. exists at a near side from a person related to the detected face image, there is a possibility that the obstacle is focused. According to an example shown in FIG. 16, as a result of a fence FC existing at a near side from the person HB2 having been focused, in the live view image, a sharpness of an image of the fence FC is improved whereas a sharpness of a face image of the person HB2 is deteriorated. Then, processes corresponding to the problem are executed in a manner described below

The CPU 26 calculates an estimated distance Df between the focus lens 12 and the face of the person stored in the AF target register RGSTaf. The estimated distance Df is obtained by Equation 3 indicated below by using the reference face size Sf registered in the dictionary number corresponding to the AF-target face information of the registered face dictionary DCrg.

Df=Af/Sf [Equation 3]
Af: the size stored in the AF-target register RGSTaf

The CPU 26 determines whether or not an AF distance Da is included within a range from the estimated distance Df thus calculated to a predetermined value a.

When a determined result is negative, the CPU 26 determines that the obstacle is focused by the strict AF process, and commands the driver 18a to adjust the position of the focus lens 12 based on the estimated distance Df. As a result, the focus lens 12 is placed so that the subject distance is coincident with the estimated distance Df. When the determined result is positive, it is determined that the person is focused by the strict AF process, and the subject distance is not adjusted.

It is noted that, when the reference human-body size Sb is registered in the dictionary number corresponding to the AF-target face information of the registered face dictionary DCrg, an estimated distance Db is calculated, and the subject distance is adjusted by using the estimated distance Db instead of the estimated distance Df. This is because the size of the human-body including the face is larger than the size of the face of the person and the adjustment accuracy is improved specifically when the subject distance becomes longer.

In this case, the image of the human body including the region indicated by the AF-target face information is detected from the search image data by using the standard human-body dictionary DCsb. When the human-body image is detected, the CPU 26 calculates the estimated distance Db between the focus lens 12 and the human-body of the person stored in the AF-target register RGSTrg. The estimated distance Db is obtained by Equation 4 indicated below by using the reference human-body size Sb.

Db=Ab/Sb [Equation 4]
Ab: the size of the human-body image

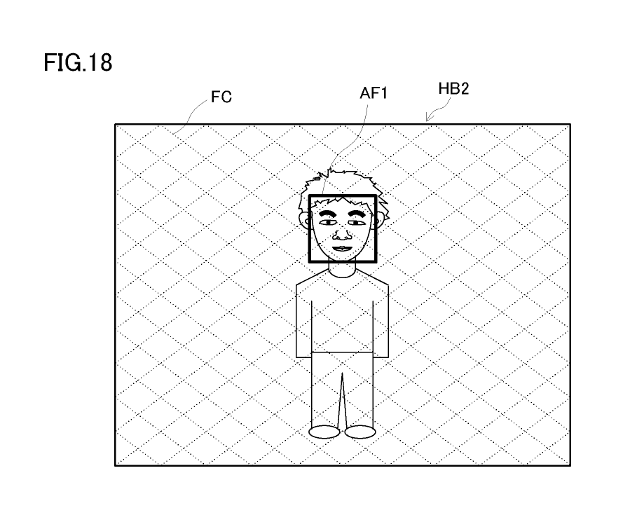

With reference to FIG. 17, when the fence FC is focus by the strict AF process as in an example shown in FIG. 16, the AF distance Da is equivalent to a distance between the fence FC and the focus lens 12. Therefore, it becomes possible to focus the person HB2 as shown in FIG. 18 by making the subject distance correspond to the estimated distance Df or Db indicating the distance between the person HB2 and the focus lens 12.

Moreover, when the flag FLG_f indicates “1”, under the imaging task the CPU 26 requests the graphic generator 46 to display a face frame structure AF with reference to contents of the AF-target register RGSTaf. The graphic generator 46 outputs graphic information representing the face frame structure AF toward the LCD driver 38. The face frame structure AF is displayed on the LCD monitor 38 in a manner adapted to the position and size stored in the AF-target register RGSTaf.

Thus, when the AF process for person is executed to the face of the person HB2, the face frame structure AF 1 is displayed on the LCD monitor 38 as shown in FIG. 18, in a manner to surround the face image of the person HB2.

When the flag FLG_f indicates “0”, under the imaging task, the CPU 26 executes a strict AF process in which a center of the screen is noticed. The CPU 26 extracts, out of the 256 AF evaluation values outputted from the AF evaluating circuit 24, an AF evaluation value corresponding to the center of the screen. The CPU 26 executes an AF process that is based on the extracted partial AF evaluation value. As a result, a sharpness of the center of the screen in the live view image or the recorded image is improved.

Upon completion of the AF process, the CPU 26 commands the driver 18b to adjust the aperture unit 14 to a small aperture amount. As a result, a depth of field is changed to a shallow level.

Moreover, under the imaging task, the CPU 26 executes a strict AE process based on the 256 AE evaluation values outputted from the AE evaluating circuit 22. An aperture amount and an exposure time period that define the optimal EV value calculated by the strict AE process are set to the drivers 18b and 18c, respectively. Thereby, a brightness of the live view image or the recorded image is adjusted strictly.

When the shutter button 28sh is fully depressed, the CPU 26 executes the still-image taking process and the recording process. One frame of raw image data at a time point at which the shutter button 28sh is fully depressed is taken into the still image area 32d of the SDRAM 32 by the still-image taking process. Moreover, one still-image file is created in a recording medium 42 by the recording process. The taken raw image data is recorded in the still-image file newly created, by the recording process.

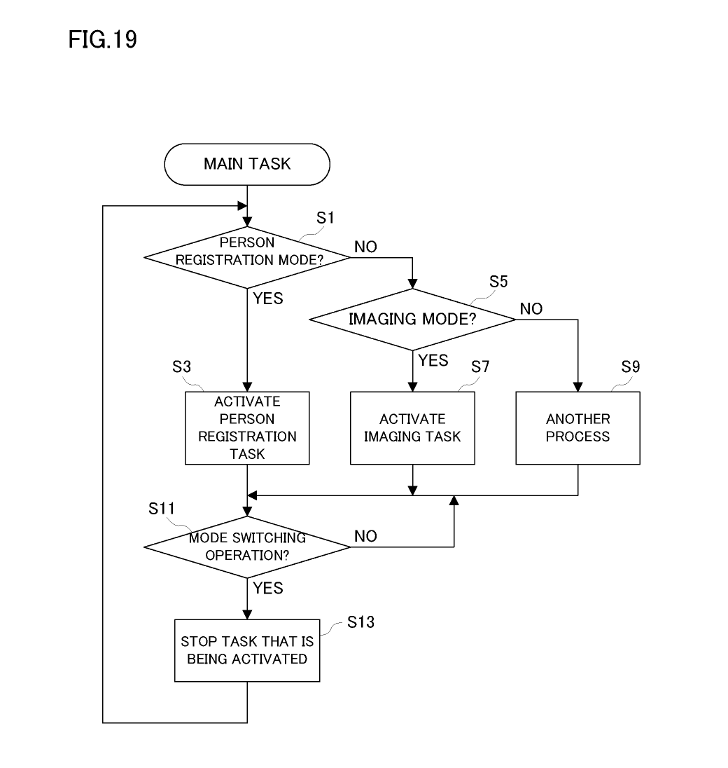

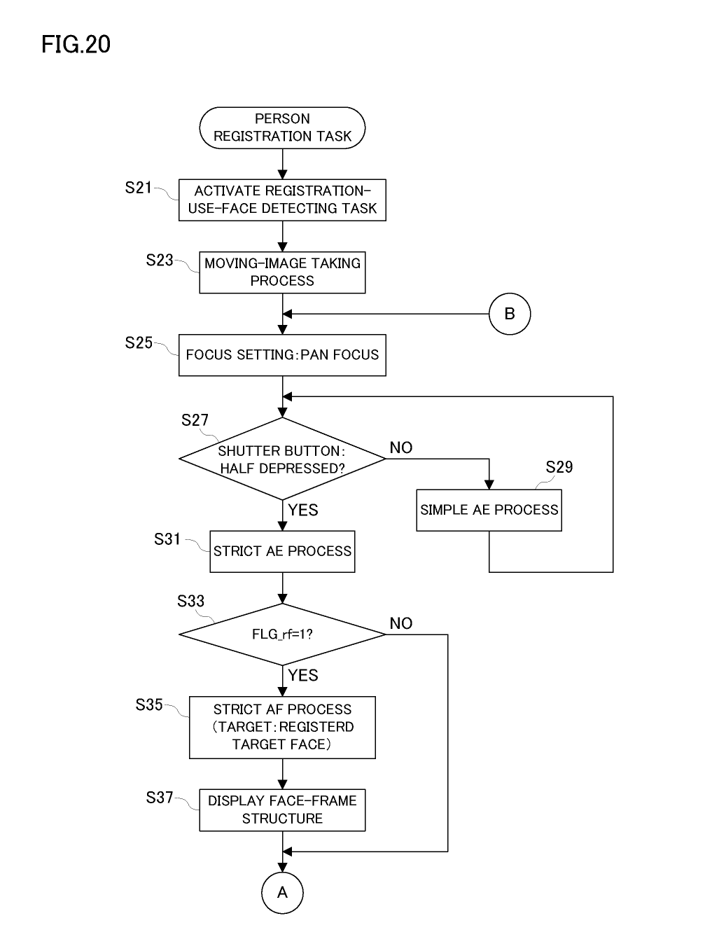

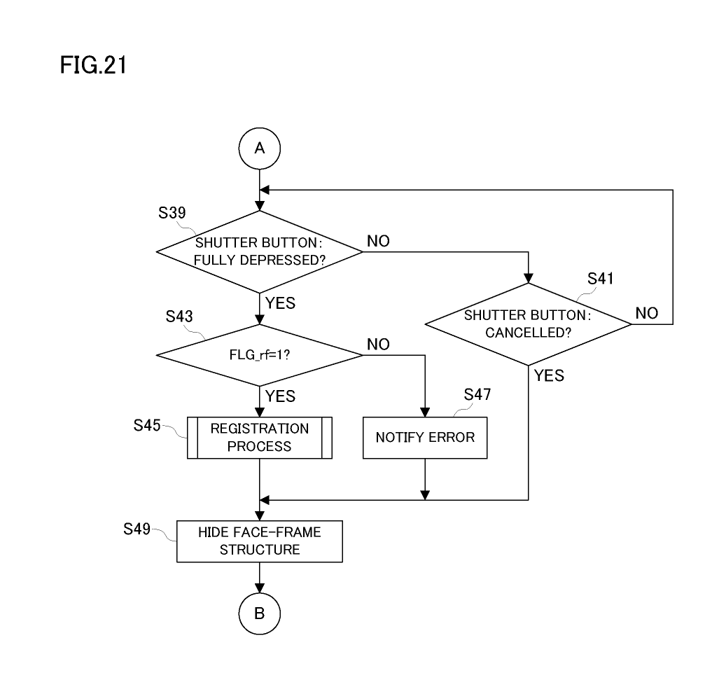

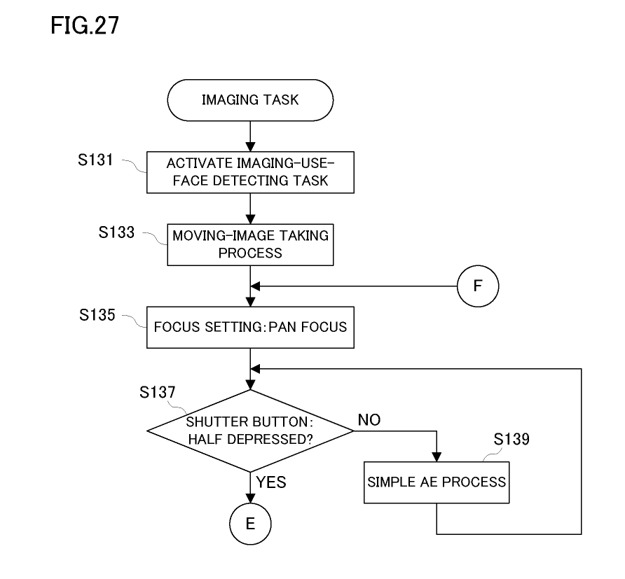

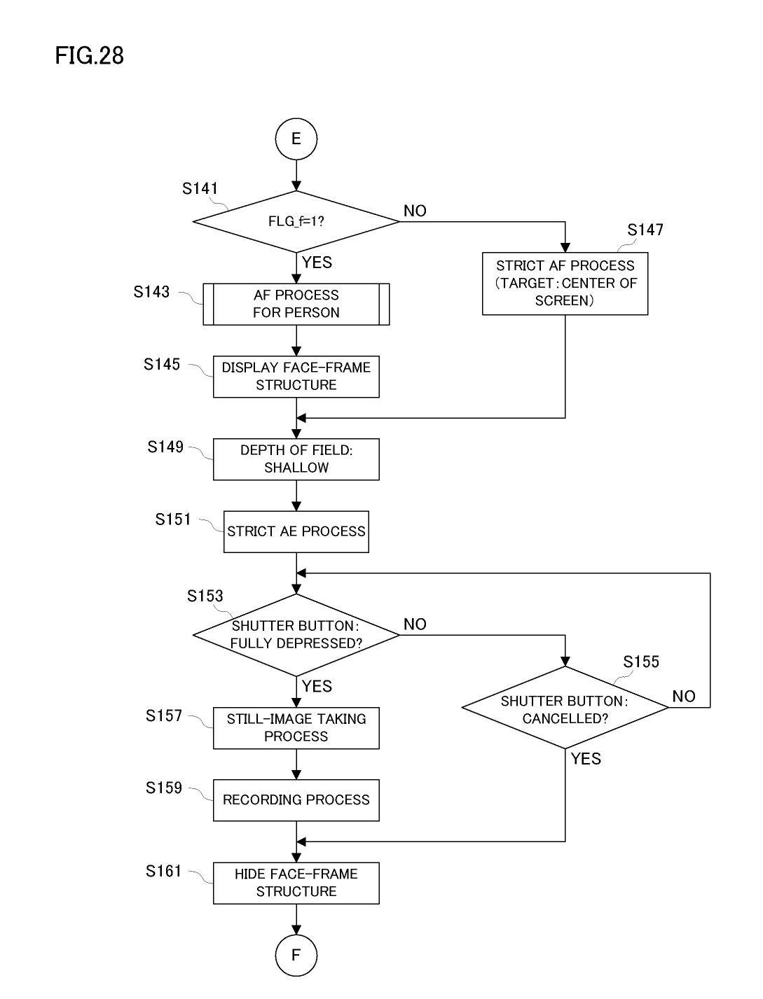

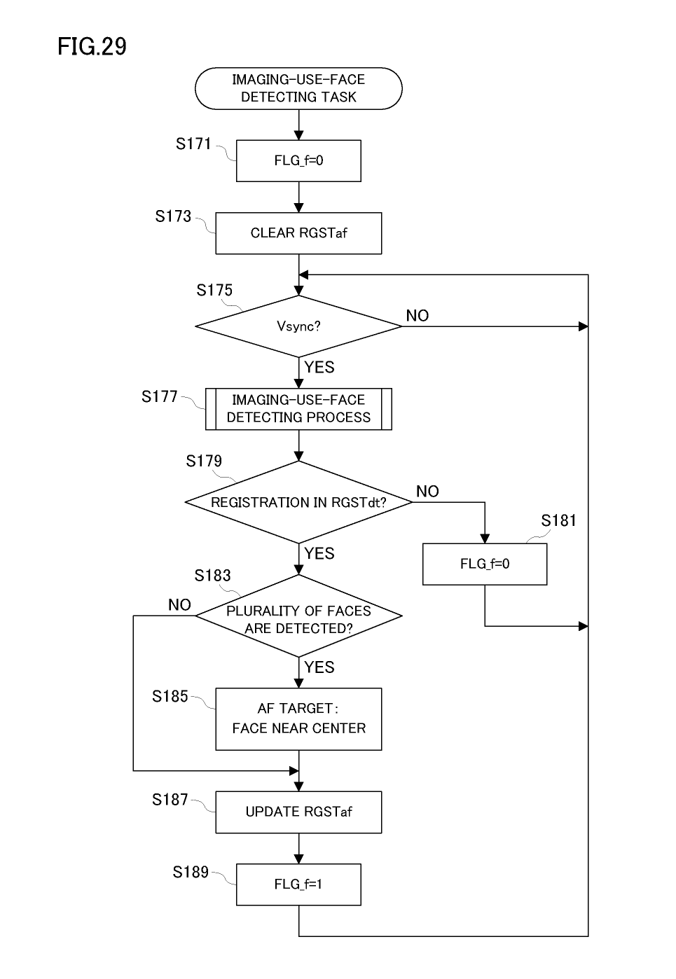

The CPU 26 executes a plurality of tasks including the main task shown in FIG. 19, the person registration task shown in FIG. 20 to FIG. 21, the imaging task shown in FIG. 27 to FIG. 28 and the imaging-use face detecting task shown in FIG. 29, in a parallel manner. It is noted that control programs corresponding to these tasks are stored in the flash memory 44.

With reference to FIG. 19, in a step S1, it is determined whether or not an operation mode at a current time point is the person registration mode, and when a determined result is YES, in a step S3, the person registration task is activated. When the determined result is NO, in a step S5, the operation mode at the current time point is the imaging mode. When a determined result of the step S5 is YES, the imaging task is activated in a step S7 whereas when the determined result is NO, another process is executed in a step S9.

Upon completion of the process in the step S3, S7 or S9, in a step S11, it is repeatedly determined whether or not a mode switching operation is performed. When the determined result is updated from NO to YES, the task that is being activated is stopped in a step S13, and thereafter, the process returns to the step S1.

With reference to FIG. 20, in a step S21, the registration-use-face detecting task is activated, and in a step S23, the moving-image taking process is started. As a result, a live view image representing the scene is displayed on the LCD monitor 38.

In a step S25, the focus lens 12 is placed at the pan focus position which is the initial setting position. In a step S27, it is determined whether or not the shutter button 28sh is half depressed, and during a determined result is NO, the simple AE process is executed in a step S29. As a result, a brightness of the live view image is adjusted approximately. When the determined result is updated from NO to YES, the strict AE process is executed in a step S31. As a result, the brightness of the live view image is adjusted strictly.

In a step S33, it is determined whether or not the flag FLG_r indicates “1”, and when a determined result is NO, the process advances to a step S39 whereas when the determined result is YES, the process advances to the step S39 via processes in steps S35 and S37.

In the step S35, executed is a strict AF process in which a region indicated by the registered target face information is noticed. As a result, the focus lens 12 is placed at a focal point in which the region indicated by the registered target face information is noticed, and thereby, a sharpness of a face of a registration target in the live view image is improved. In the step S37, the graphic generator 46 is commanded to display the face frame structure RF. As a result, the face frame structure RF is displayed on the LCD monitor 38 in a manner adapted to the position and size stored in the registration-target register RGSTrg.

In the step S39, it is determined whether or not the shutter button 28sh is fully depressed, and when a determined result is NO, in a step S41, it is determined whether or not a half-depressed state of the shutter button 28sh is cancelled. When a determined result of the step S41 is NO, the process returns to the step S39 whereas when the determined result of the step S41 is YES, the process advances to a step S49.

When a determined result of the step S39 is YES, in a step S43, it is determined whether or not the flag FLG_rf indicates “1”. When a determined result of the step S43 is YES, the process advances to the step S49 via a process in a step S45 whereas when the determined result of the step S43 is NO, the process advances to the step S49 via a process in a step S47.

In the step S45, in order to register a dictionary on the registration-use-face dictionary DCrg based on the registered target face information, the registration process is executed. In the step S47, in order to declare that the face of the person is undiscovered, an error message is displayed on the LCD monitor 38. In the step S49, the face-frame structure RF is hidden, and thereafter, the process returns to the step S25.

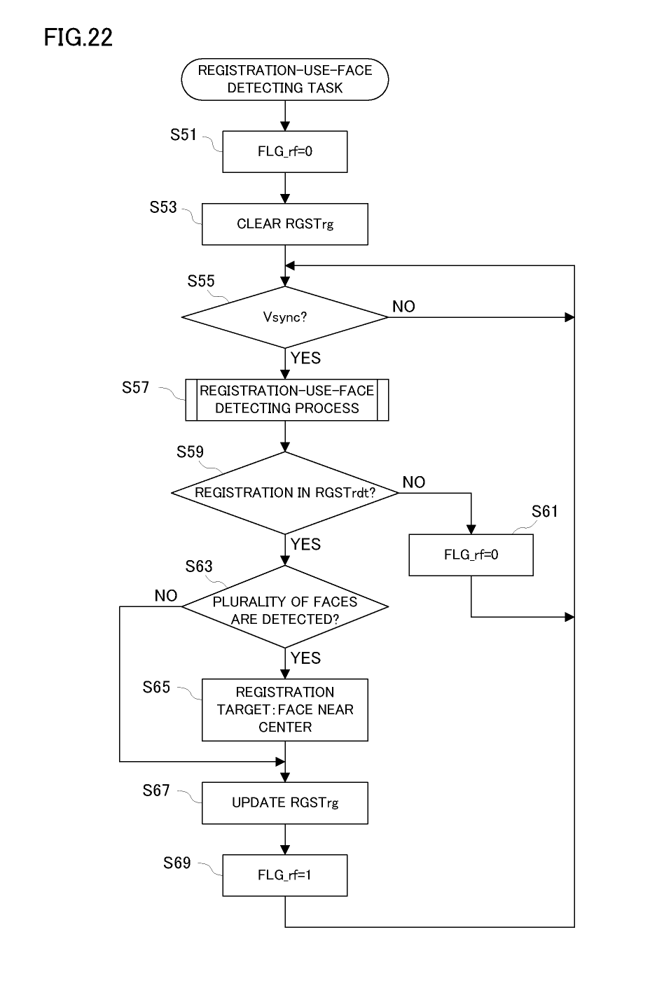

With reference to FIG. 22, in a step S51, the flag FLG_rf is set to “0”, and in a step S53, the stored contents of the registration-target register RGSTrg are cleared so as to be initialized. In a step S55, it is repeatedly determined whether or not the vertical synchronization signal Vsync is generated, and when a determined result is updated from NO to YES, the process advances to a step S57.

In the step S57, in order to search for a face image of the person from the search image data, the registration-use-face detecting process is executed. In a step S59, it is determined whether or not the face information is stored in the registration-use-face-detection register RGSTrdt, and when a determined result is YES, the process advances to a step S63 whereas when the determined result is NO, the process advances to a step S61. In the step S61, the flag FLG_rf is set to “0”, and thereafter, the process returns to the step S55.

In the step S63, it is determined whether or not a plurality of the face information are stored in the registration-use-face-detection register RGSTrdt, and when a determined result is NO, the process advances to a step S67 whereas when the determined result is YES, the process advances to the step S67 via a process in a step S65.

In the step S65, face information in which a position registered in the registration-use-face-detection register RGSTrdt is the nearest to the center of the imaging surface is determined as the registered target face information, and in the step S67, a position and a size of the face information used as the registered target face information are stored in the registration-target register RGSTrg. In a step S69, the flag FLG_rf is set to “1”, and thereafter, the process returns to the step S55.

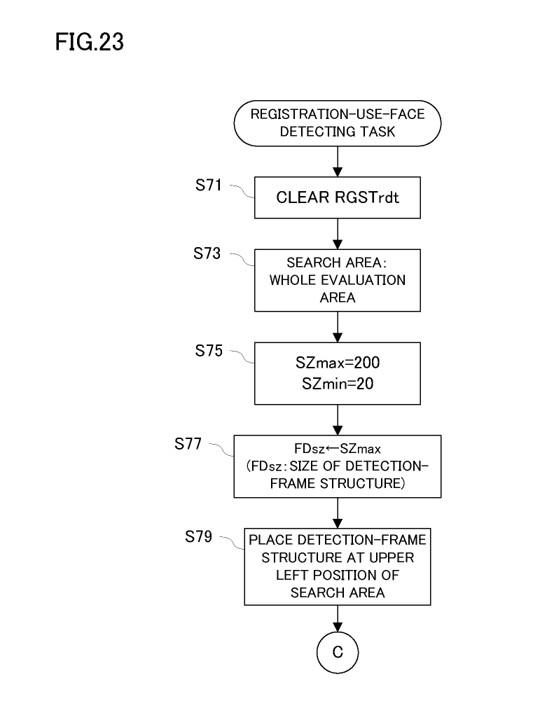

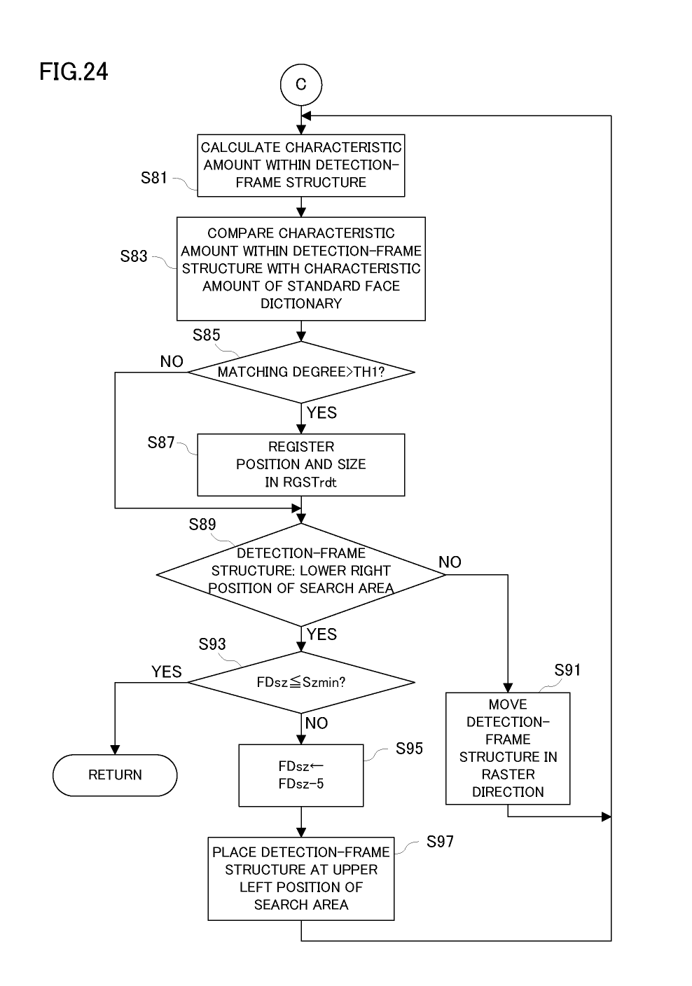

The registration-use-face detecting process in the step S57 is executed according to a subroutine shown in FIG. 23 to FIG. 24.

With reference to FIG. 23, in a step S71, in order to initialize the registration-use-face-detection register RGSTrdt, the stored contents are cleared.

In a step S73, the whole evaluation area EVA is set as a search area. In a step S75, in order to define a variable range of the size of the face-detection frame structure FD, the maximum size SZmax is set to “200”, and the minimum size SZmin is set to “20”.

In a step S77, the size of the face-detection frame structure FD is set to “SZmax”, and in a step S79, the face-detection frame structure FD is placed at the upper left position of the search area. In a step S81, partial search image data belonging to the face-detection frame structure FD is read out from the search image area 32c so as to calculate a characteristic amount of the read-out search image data.

In a step S83, the characteristic amount calculated in the step S81 is compared with a characteristic amount of the dictionary image contained in the standard face dictionary DCsf. As a result of comparing, in a step S85, it is determined whether or not a matching degree exceeding the threshold value TH1 is obtained, and when a determined result is NO, the process advances to a step S89 whereas when the determined result is YES, the process advances to the step S89 via a step S87.

In the step S87, a position and a size of the face-detection frame structure FD at a current time point are registered, as face information, in the imaging-use-face-detection register RGSTdt In the step S89, it is determined whether or not the face-detection frame structure FD reaches the lower right position of the search area, and when a determined result is YES, the process advances to a step S93 whereas when the determined result is NO, in a step S91, the face-detection frame structure FD is moved by a predetermined amount in a raster direction, and thereafter, the process returns to the step S81.

In the step S93, it is determined whether or not the size of the face-detection frame structure FD is equal to or less than “SZmin”, and when a determined result is YES, the process returns to the routine in an upper hierarchy whereas when the determined result is NO, the process advances to a step S95.

In a step S95, the size of the face-detection frame structure FD is reduced by a scale of “5”, and in a step S97, the face-detection frame structure FD is placed at the upper left position of the search area. Upon completion of the step S97, the process returns to the step S81.

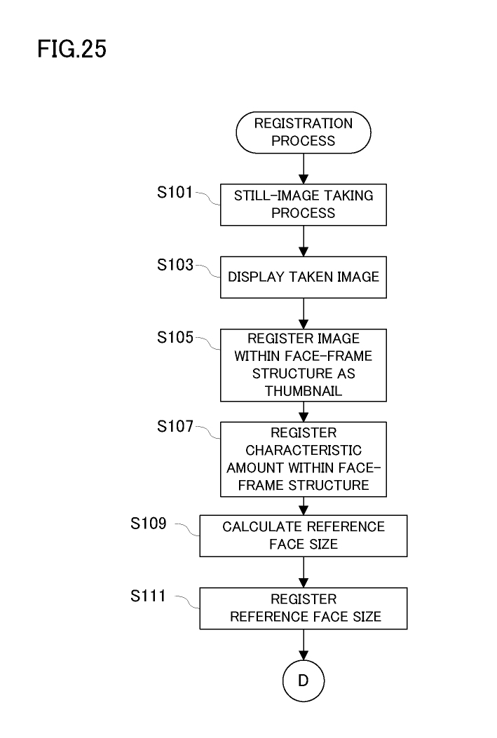

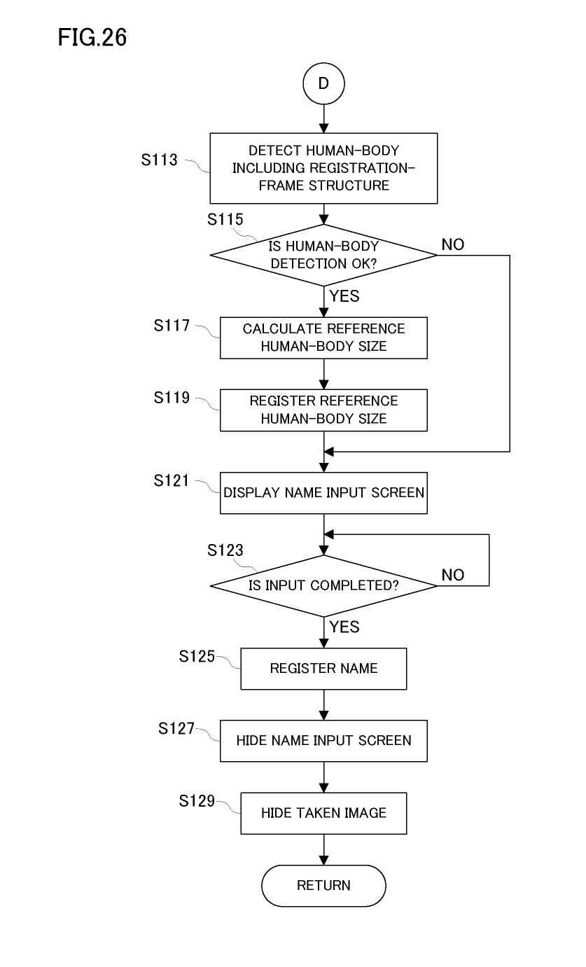

The registration process in the step S45 is executed according to a subroutine shown in FIG. 25 to FIG. 26.

With reference to FIG. 25, in a step S101, the still-image taking process is executed. As a result, one frame of image data at a time point at which the shutter button 28sh is fully depressed is taken into the still image area 32d of the SDRAM 32 by the still-image taking process. In a step S103, updating the display image area 32b is stopped. As a result, a still image at the time point at which the shutter button 28sh is fully depressed is displayed on the LCD monitor 38.

In a step S105, image data corresponding to the position and size stored in the registration-target register RGSTrg out of the display image data is registered in the registered face dictionary DCrg as a thumbnail image, and in a step S107, a characteristic amount of the image data is registered in the registered face dictionary DCrg.

In a step S109, a reference face size Sf representing a size per unit subject distance of the registered target face information is calculated, and in a step S111, the calculated reference face size Sf is registered in the registered face dictionary DCrg.

In a step S113, an image of the human body including the region indicated by the registered target face information is detected by using the standard human-body dictionary DCsb from the search image data. In a step S115, it is determined whether or not the human-body image is detected, and when a determined result is NO, the process advances to a step S121 whereas when the determined result is YES, the process advances to the step S121 via processes in steps S117 and S119.

In the step S117, a reference human-body size Sb representing a size per unit subject distance of the detected human-body image is calculated, and in the step S119, the calculated reference human-body size Sb is registered in the registered face dictionary DCrg.

In the step S121, the input screen is displayed so as to promote the operator to input a name of the registration target, and in a step S123, it is repeatedly determined whether or not inputting the name is completed. When a determined result is updated from NO to YES, in a step S125, the inputted name is registered in the registered face dictionary DCrg.

In a step S127, a name input screen displayed in the step S121 is hidden, and in a step S129, the taken image displayed in the step S103 is hidden Thereafter, the process returns to the routine in an upper hierarchy.

With reference to FIG. 27, in a step S131, the imaging-use-face detecting task is activated, and in a step S133, the moving-image taking process is started. As a result, a live view image representing the scene is displayed on the LCD monitor 38.

In a step S135, the focus lens 12 is placed at the pan focus position which is the initial setting position. In a step S137, it is determined whether or not the shutter button 28sh is half depressed, and during a determined result is NO, the simple AE process is executed in a step S139. As a result, a brightness of the live view image is adjusted approximately.

When the determined result is updated from NO to YES, in a step S141, the flag FLG_f indicates “1”, and when a determined result is YES, the process advances to a step S149 via processes in steps S143 and S145 whereas when the determined result is NO, the process advances to the step S149 via a process in a step S147.

In the step S143, the AF process for person is executed. In the step S145, the graphic generator 46 is requested to display the face frame structure AF. As a result, the face frame structure AF is displayed on the LCD monitor 38 in a manner adapted to the position and size stored in the AF-target register RGSTaf.

In the step S147, the strict AF process in which a center of the screen is noticed is executed. As a result, a sharpness of the center of the screen in the live view image or the recorded image is improved.

In the step S149, the driver 18b is commanded to adjust the aperture unit 14 to a small aperture amount. As a result, a depth of field is changed to a shallow level. In a step S151, the strict AE process is executed. Thereby, a brightness of the live view image or the recorded image is adjusted strictly.

In a step S153, it is determined whether or not the shutter button 28sh is fully depressed, and when a determined result is NO, in a step S155, it is determined whether or not the half-depressed state of the shutter button 28sh is cancelled. When a determined result of the step S155 is NO, the process returns to the step S153 whereas when the determined result of the step S155 is YES, the process advances to a step S161.

When a determined result of the step S153 is YES, the still-image taking process is executed in a step S157, and the recording process is executed in a step S159. One frame of raw image data at a time point at which the shutter button 28sh is fully depressed is taken into the still image area 32d of the SDRAM 32 by the still-image taking process. Moreover, one still-image file is created in the recording medium 42 by the recording process. The taken raw image data is recorded in the still-image file newly created, by the recording process. In the step S161, the face-frame structure AF is hidden, and thereafter, the process returns to the step S135.

With reference to FIG. 29, in a step S171, the flag FLG_f is set to “0”, and in a step S173, the stored contents of the AF-target register RGSTaf are cleared so as to be initialized. In a step S175, it is repeatedly determined whether or not the vertical synchronization signal Vsync is generated, and when a determined result is updated from NO to YES, the process advances to a step S177.

In the step S177, in order to search for the face image of the person from the search image data, the imaging-use-face detecting process is executed. In a step S179, it is determined whether or not the face information is stored in the imaging-use-face-detection register RGSTdt, and when a determined result is YES, the process advances to a step S183 whereas when the determined result is NO, the process advances to a step S181. In the step S181, the flag FLG_f is set to “0”, and thereafter, the process returns to the step S175.

In the step S183, it is determined whether or not a plurality of the face information are stored in the imaging-use-face-detection register RGSTdt, and when a determined result is NO, the process advances to a step S187 whereas when the determined result is YES, the process advances to the step S187 via a process in a step S185.

In the step S185, face information in which a position registered in the imaging-use-face-detection register RGSTdt is the nearest to the center of the imaging surface is determined as the AF-target face information, and in the step S187, a position and a size of the face information used as the AF-target face information are stored in the AF-target register RGSTaf. In a step S189, the flag FLG_f is set to “1”, and thereafter, the process returns to the step S175.

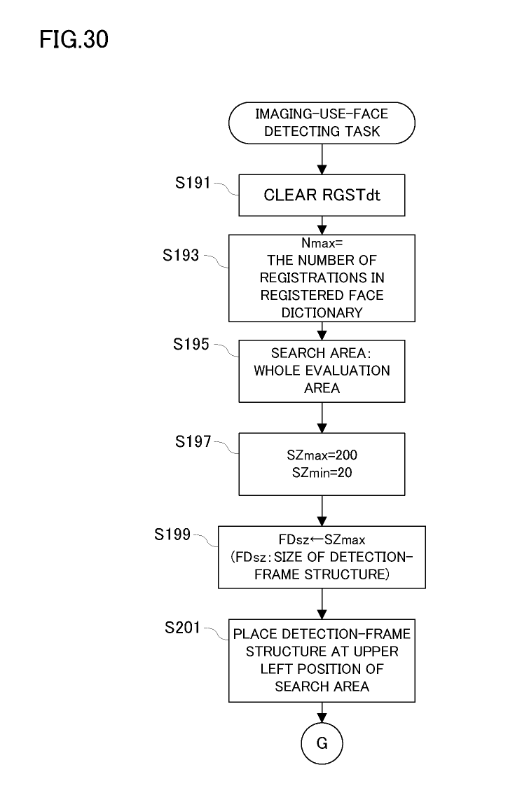

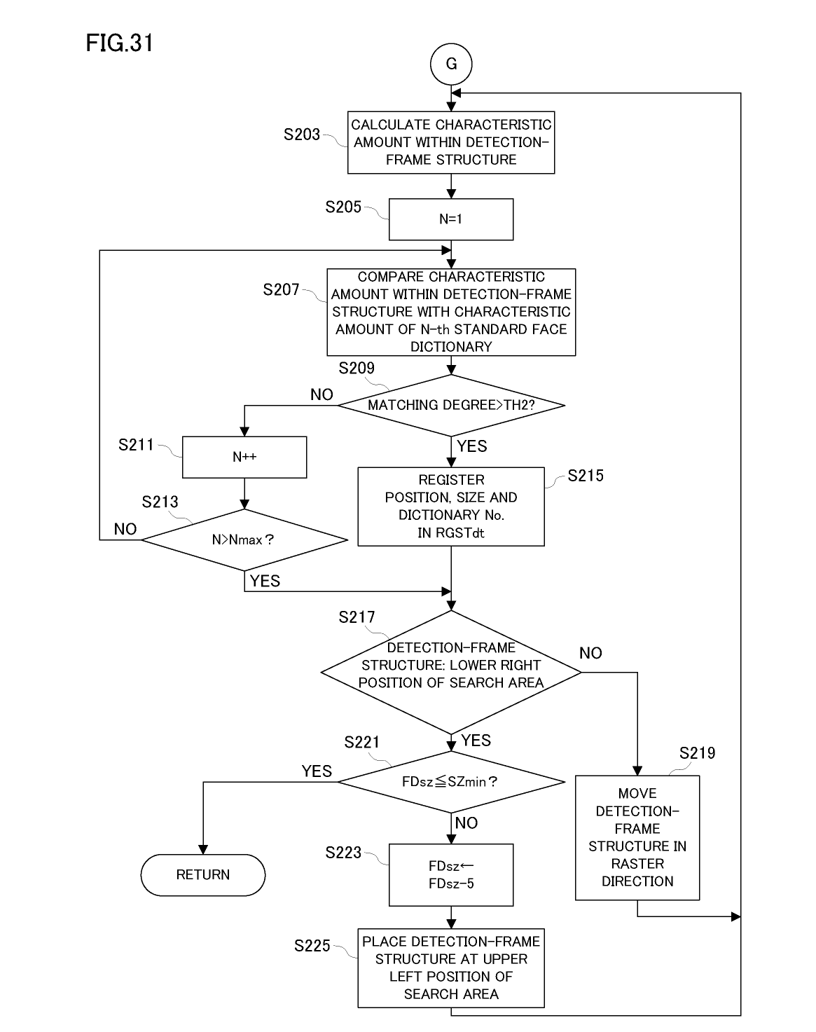

The imaging-use-face detecting process in the step S177 is executed according to a subroutine shown in FIG. 30 to FIG. 31.

With reference to FIG. 30, in a step S191, in order to initialize the imaging-use-face-detection register RGSTdt, the stored contents are cleared.

In a step S193, a variable Nmax is set to the number of registrations in the registered face dictionary DCrg, and in a step S195, the whole evaluation area EVA is set as a search area. In a step S197, in order to define a variable range of the size of the face-detection frame structure FD, structure FD, the maximum size SZmax is set to “200”, and the minimum size SZmin is set to “20”.

In a step S199, the size of the face-detection frame structure FD is set to “SZmax”, and in a step S201, the face-detection frame structure FD is placed at the upper left position of the search area. In a step S203, partial search image data belonging to the face-detection frame structure FD is read out from the search image area 32c so as to calculate a characteristic amount of the read-out search image data.

In a step S205, a variable N is set to “1”, and in a step S207, the characteristic amount calculated in the step S203 is compared with a characteristic amount of the dictionary image contained in the N-th of the registered face dictionary DCrg. As a result of comparing, in a step S209, it is determined whether or not a matching degree exceeding the threshold value TH2 is obtained, and when a determined result is NO, the process advances to a step S211 whereas when the determined result is YES, the process advances to a step S215.

In a step S211, the variable N is incremented, and in a step S213, it is determined whether or not the variable N exceeds “Nmax”. When a determined result is NO, the process returns to the step S207 whereas when the determined result is YES, the process advances to a step S217.

In the step S215, a position and a size of the face-detection frame structure FD at a current time point are registered, as face information, in the imaging-use-face-detection register RGSTdt In the step S217, it is determined whether or not the face-detection frame structure FD reaches the lower right position of the search area, and when a determined result is YES, the process advances to a step S221 whereas when the determined result is NO, in a step S219, the face-detection frame structure FD is moved by a predetermined amount in a raster direction, and thereafter, the process returns to the step S203.

In the step S221, it is determined whether or not the size of the face-detection frame structure FD is equal to or less than “SZmin”, and when a determined result is YES, the process returns to the routine in an upper hierarchy whereas when the determined result is NO, the process advances to a step S223.

In a step S223, the size of the face-detection frame structure FD is reduced by a scale of “5”, and in a step S225, the face-detection frame structure FD is placed at the upper left position of the search area. Upon completion of the step S225, the process returns to the step S203.

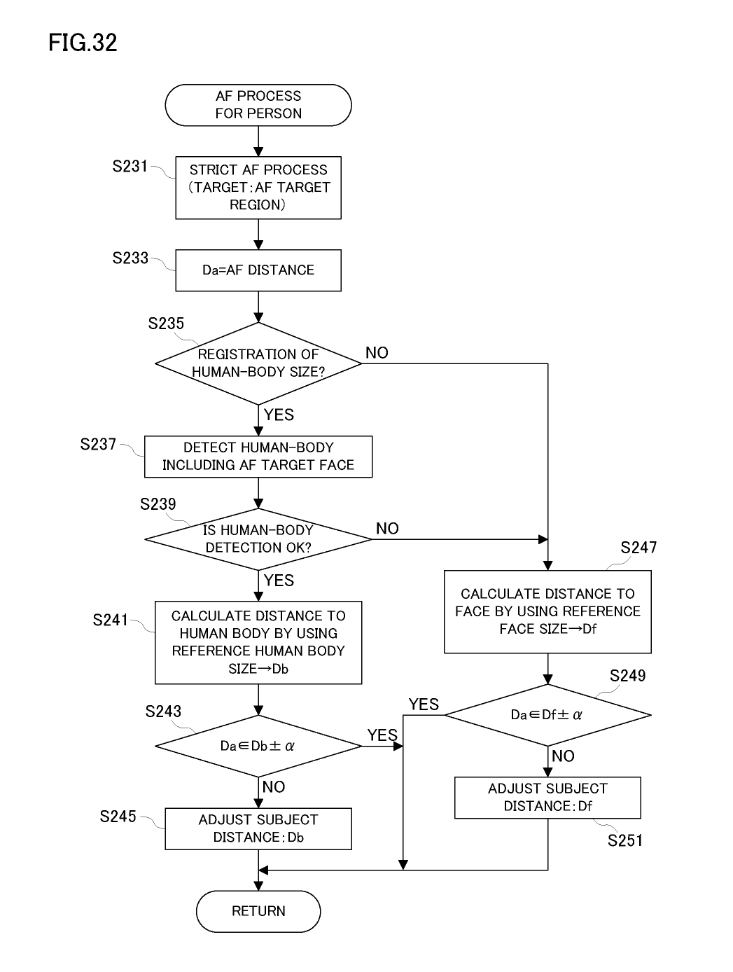

The AF process for person in the step S143 is executed according to a subroutine shown in FIG. 32.

With reference to FIG. 32, in a step S231, the strict AF process in which a region indicated by the AF-target face information is noticed. As a result, the focus lens 12 is placed at a focal point in which the region indicated by the AF-target face information is noticed, and thereby, improved is a sharpness of the region indicated by the AF-target face information in the live view image or the recorded image. In a step S233, a subject distance after the strict AF process is completed is set as the AF distance Da.

In a step S235, it is determined whether or not the reference human-body size Sb is registered in the dictionary number corresponding to the AF-target face information of the registered face dictionary DCrg, and when a determined result is NO, the process advances to a step S247 whereas when the determined result is YES, the process advances to a step S237.

In the step S237, the image of the human body including the region indicated by the AF-target face information is detected from the search image data by using the standard human-body dictionary DCsb. In a step S239, it is determined whether or not the human-body image is detected by the detecting process in the step S237, and when a determined result is NO, the process advances to the step S247 whereas when the determined result is YES, the process advances to a step S241.

In the step S241, the estimated distance Db between the focus lens 12 and the human-body of the person stored in the AF target register RGSTaf is calculated by using the reference human-body size Sb registered in the dictionary number corresponding to the AF-target face information of the registered face dictionary DCrg.

In a step S243, it is determined whether or not the AF distance Da is included within a range from the estimated distance Db calculated in the step S241 to the predetermined value a. When a determined result is YES, it is determined that the person is focused by the strict AF process, and the process returns to the routine in an upper hierarchy whereas when the determined result is NO, it is determined that the obstacle is focused by the strict AF process, and the process advances to a step S245.

In the step S245, the driver 18a is commanded to adjust the position of the focus lens 12 based on the estimated distance Db. As a result, the focus lens 12 is placed so that the subject distance is coincident with the estimated distance Db.

In the step S247, the estimated distance Df between the focus lens 12 and the human-body of the person stored in the AF target register RGSTaf is calculated by using the reference face size Sf registered in the dictionary number corresponding to the AF-target face information of the registered face dictionary DCrg.

In a step S249, it is determined whether or not the AF distance Da is included within a range from the estimated distance Df calculated in the step S247 to the predetermined value a. When a determined result is YES, it is determined that the person is focused by the strict AF process, and the process returns to the routine in an upper hierarchy whereas when the determined result is NO, it is determined that the obstacle is focused by the strict AF process, and the process advances to a step S251.

In the step S251, the driver 18a is commanded to adjust the position of the focus lens 12 based on the estimated distance Df. As a result, the focus lens 12 is placed so that the subject distance is coincident with the estimated distance DE

Upon completion of the step S245 or S251, the process returns to the routine in an upper hierarchy.

As can be seen from the above-described explanation, the image sensor 16 repeatedly outputs an image representing a scene. The CPU 26 executes the process of searching for the face image from the image outputted from the image sensor 16, corresponding to the person registration mode. Moreover, the CPU 26 detects the size of the detected face image, and adjusts the subject distance by noticing the detected face image. The CPU 26 executes the process of searching for the partial image equivalent to the detected face image from the image outputted from the image sensor 16, corresponding to the imaging mode which is the alternative to the person registration mode, and adjusts the subject distance based on the difference between the size of the detected partial image and the size previously detected and the previous adjustment result

The face image is searched based on the face image once detected. Moreover, the subject distance is adjusted based on the difference between the sizes of the face images of the twice detections and the adjustment result of the first detection. Thereby, it becomes possible to improve the adjustment accuracy of the subject distance more than adjusting based on the standard size.

It is noted that, in this embodiment, the position and size of the registration target or the position and size of the AF target are determined when the shutter button 28sh is half depressed, however, these targets may be updated by a tracking process during the half-depressing is continued, for example.

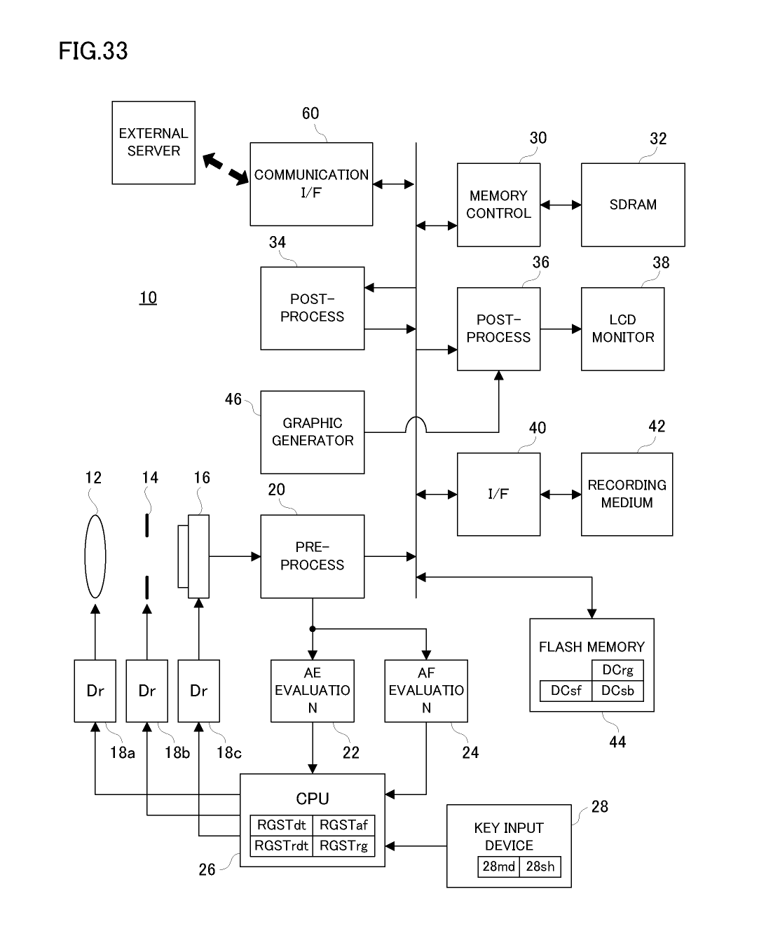

It is noted that, in this embodiment, the control programs equivalent to the multi task operating system and a plurality of tasks executed thereby are previously stored in the flash memory 44. However, a communication I/F 60 may be arranged in the digital camera 10 as shown in FIG. 33 so as to initially prepare a part of the control programs in the flash memory 44 as an internal control program whereas acquire another part of the control programs from an external server as an external control program. In this case, the above-described procedures are realized in cooperation with the internal control program and the external control program.

Furthermore, in this embodiment, the processes executed by the main CPU 26 are divided into a plurality of tasks including the main task shown in FIG. 19, the person registration task shown in FIG. 20 to FIG. 21, the registration-use-face detecting task shown in FIG. 22, the imaging task shown in FIG. 27 to FIG. 28 and the imaging-use-face detecting task shown in FIG. 29. However, these tasks may be further divided into a plurality of small tasks, and furthermore, a part of the divided plurality of small tasks may be integrated into another task Moreover, when each of tasks is divided into the plurality of small tasks, the whole task or a part of the task may be acquired from the external server.

Moreover, in this embodiment, the present invention is explained by using the digital still camera, however, a digital video camera, cell phone units, or a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which repeatedly outputs an image representing a scene;
a first searcher which searches for a specific object image from the image outputted from said imager, corresponding to a first mode;
a first detector which detects a size of the specific object image detected by said first searcher;
a first adjuster which adjusts an imaging condition by noticing the specific object image detected by said first searcher;
a second searcher which searches for a partial image equivalent to the specific object image detected by said first searcher from the image outputted from said imager, corresponding to a second mode which substitutes for the first mode; and
a second adjuster which adjusts the imaging condition based on a difference between a size of the partial image detected by said second searcher and the size detected by said first detector and an adjustment result of said first adjuster.

2. An electronic camera according to claim 1, wherein said imager includes an imaging surface capturing the scene through a focus lens, and the imaging condition is equivalent to a distance from said focus lens to said imaging surface.

3. An electronic camera according to claim 1, further comprising a characteristic amount detector which detects a characteristic amount of the specific object image detected by said first searcher, wherein the partial image detected by said second searcher is equivalent to a partial image having a characteristic amount of which a matching degree to the characteristic amount detected by said characteristic amount detector is equal to or more than a predetermined value.

4. An electronic camera according to claim 1, further comprising:
a third adjuster which adjusts the imaging condition by noticing the partial image detected by said second searcher;
a difference detector which detects a difference between the imaging condition adjusted by said second adjuster and the imaging condition adjusted by said third adjuster; and
a setter which sets one imaging condition different depending on the difference detected by said difference detector, out of two imaging conditions notice by said difference detector.

5. An electronic camera according to claim 1, wherein the specific object image is equivalent to a face image of a person.

6. An electronic camera according to claim 1, further comprising:
a third searcher which searches for a human-body image of a person including the face image detected by said first searcher from the image outputted from said imager, corresponding to the first mode;
a second detector which detects a size of the human-body image detected by said third searcher; and
a fourth searcher which searches for a partial image equivalent to a human-body image of a person including the image detected by said second searcher from the image outputted from said imager, corresponding to the second mode, wherein said second adjuster executes, in association with detection of said fourth detector, a process of adjusting the imaging condition by using a difference between a size of the partial image detected by said fourth searcher and the size detected by said second detector, instead of the difference between the size of the partial image detected by said second searcher and the size detected by said first detector.

7. An imaging control program recorded on a non-transitory recording medium in order to control an electronic camera provided with an imager which repeatedly outputs an image representing a scene, the program causing a processor of the electronic camera to perform the steps comprises:
a first searching step of searching for a specific object image from the image outputted from said imager, corresponding to a first mode;
a first detecting step of detecting a size of the specific object image detected by said first searching step;
a first adjusting step of adjusting an imaging condition by noticing the specific object image detected by said first searching step;
a second searching step of searching for a partial image equivalent to the specific object image detected by said first searching step from the image outputted from said imager, corresponding to a second mode which substitutes for the first mode; and
a second adjusting step of adjusting the imaging condition based on a difference between a size of the partial image detected by said second searching step and the size detected by said first detecting step and an adjustment result of said first adjusting step.

8. An imaging control method executed by an electronic camera provided with an imager which repeatedly outputs an image representing a scene, comprising:
a first searching step of searching for a specific object image from the image outputted from said imager, corresponding to a first mode;
a first detecting step of detecting a size of the specific object image detected by said first searching step;
a first adjusting step of adjusting an imaging condition by noticing the specific object image detected by said first searching step;
a second searching step of searching for a partial image equivalent to the specific object image detected by said first searching step from the image outputted from said imager, corresponding to a second mode which substitutes for the first mode; and
a second adjusting step of adjusting the imaging condition based on a difference between a size of the partial image detected by said second searching step and the size detected by said first detecting step and an adjustment result of said first adjusting step.
